(19) United States
(12) Patent Application Publication
(10) Pub. No.: US 2012/0257817 A1
(43) Pub. Date: Oct. 11, 2012

(54) IMAGE OUTPUT APPARATUS

(76) Inventor: Koichi Arima, Kawasaki (JP)

(21) Appl. No.: 13/515,625

(22) PCT Filed: Dec. 15, 2009
(86) PCT No.: PCT/JP09/70899

§ 371 Date: Jun. 13, 2012

(51) Int. Cl. G06K 9/36

(52) U.S. Cl. 382/154

(57) ABSTRACT

An image output apparatus (1) is provided with: a first decoding device (21) and a second decoding device (22) for decoding each of left-eye image data and right-eye image data associated with three-dimensional data and for outputting first and second image signals, respectively; a third decoding device (21) for decoding two-dimensional image data and for outputting a third image signal; a switching device (23, 24, SW1) for selecting the first and second image signals alternately at predetermined intervals when the three-dimensional image is outputted and for selecting the third image signal when the two-dimensional image is outputted; an interpolating device (26) for interpolating the third image signal such that a frame frequency and resolution associated with the third image signal match a frame frequency and resolution associated with each of the first image signal and the second image signal when the two-dimensional image is outputted; and an outputting device (27) for outputting the first and second image signals as an output signal when the three-dimensional image is outputted and for outputting the interpolated third image signal as the output signal when the two-dimensional image is outputted.

### TECHNICAL FIELD

The present invention relates to an image output apparatus for changing between images having different display specifications such as, for example, a two-dimensional image and a three-dimensional image.

### BACKGROUND ART

This type of apparatus prevents distorted images and audio from being provided for a user, for example, in changing from an image having one display specification to an image having another display specification. For example, a patent document 1 describes an apparatus for forming image data which includes an image corresponding to output-target image data and which matches a fixed display specification, by performing a predetermined process including a combination process if the fixed display specification, which is one display specification used for fixation (e.g. 1920×1080p) does not match a display specification of the output-target image data (e.g. 720×480p/4:3) and if the display specification of the output-target image data cannot be converted to match the fixed display specification.

### PRIOR ART DOCUMENT

### Patent Document

Patent document 1: Japanese Patent Application Laid Open No. 2008-258698

### DISCLOSURE OF INVENTION

### Subject to be Solved by the Invention

However, the patent document 1 does not disclose a technology in changing between a two-dimensional image and a three-dimensional image. Then, there is such a technical problem that images and audio are likely distorted in changing between the two-dimensional image and the three-dimensional image.

In view of the aforementioned problem, it is therefore an object of the present invention to provide an image output apparatus capable of changing between the two-dimensional image and the three-dimensional image without distorting images and audio.

### Means for Solving the Subject

The above object of the present invention can be achieved by an image output apparatus capable of changing between and outputting a three-dimensional image corresponding to three-dimensional image data including left-eye image data and right-eye image data and a two-dimensional image corresponding to two-dimensional image, the image output apparatus provided with: a first decoding device for decoding one image data of the left-eye image data and the right-eye image data and for outputting a first image signal corresponding to the one image data; a second decoding device for decoding the other image data of the left-eye image data and the right-eye image data and for outputting a second image signal corresponding to the other image data; a third decoding device for decoding the two-dimensional image data and for outputting a third image signal corresponding to the two-dimensional image data; a switching device for selecting the first image signal and the second image signal alternately at predetermined intervals when the three-dimensional image is outputted and for selecting the third image signal when the two-dimensional image is outputted; an interpolating device for interpolating the third image signal such that a frame frequency and resolution associated with the third image signal match a frame frequency and resolution associated with each of the first image signal and the second image signal when the two-dimensional image is outputted; and an outputting device for outputting the first image signal and the second image signal as an output signal when the three-dimensional image is outputted and for outputting the interpolated third image signal as the output signal when the two-dimensional image is outputted.

According to the image output apparatus of the present invention, the image output apparatus can change between and output a three-dimensional image corresponding to three-dimensional image data including left-eye image data and right-eye image data and a two-dimensional image corresponding to two-dimensional image.

The first decoding device which is provided with a memory, a processor, and the like decodes one image data of the left-eye image data and the right-eye image data and outputs a first image signal corresponding to the one image data.

The second decoding device which is provided with a memory, a processor, and the like decodes the other image data of the left-eye image data and the right-eye image data and outputs a second image signal corresponding to the other image data.

The third decoding device which is provided with a memory, a processor, and the like decodes the two-dimensional image data and outputs a third image signal corresponding to the two-dimensional image data.

The switching device selects the first image signal and the second image signal alternately at predetermined intervals when the three-dimensional image is outputted and selects the third image signal when the two-dimensional image is outputted.

Since the first image signal and the second image signal are selected alternately at the predetermined intervals by the switching device when the three-dimensional image is outputted, a left-eye image and a right-eye image are displayed alternately on a display. Incidentally, the “predetermined interval” is, for example, 1/120 second or the like, and it may be set to an interval for enabling a user to recognize an image as the three-dimensional image.

The interpolating device which is provided with a memory, a processor, and the like interpolates the third image signal such that a frame frequency and resolution associated with the third image signal matches a frame frequency and resolution associated with each of the first image signal and the second image signal when the two-dimensional image is outputted.

Specifically, for example, the interpolating device interpolates the third image signal, for example, such that the frame frequency and the resolution associated with the third image signal are 120 Hz and 1920×1080, respectively if the frame frequency and the resolution associated with each of the first image signal and the second image signal are 120 Hz and 1920×1080.

Here, the frame frequency may be changed, for example, by performing frame frequency conversion on the third image signal. Alternatively, the frame frequency may be changed, for example, by performing an arithmetic process on the third image signal and by generating an image signal associated with a quasi-three-dimensional image.

Here, the “quasi-three-dimensional image” means an image which is the two-dimensional image but can give a three-dimensional appearance close to the three-dimensional image. Such a “quasi-three-dimensional image” is generated, for example, by alternately arranging an original image corresponding to the third image signal and an image for producing a binocular disparity effect to some extent between the image and the original image.

Incidentally, a known frame frequency conversion technology can be applied to the frame frequency conversion. Moreover, a known resolution frequency technology can be applied to the change of the resolution.

The outputting device capable of outputting the three-dimensional image and the two-dimensional image outputs the first image signal and the second image signal as an output signal when the three-dimensional image is outputted and outputs the interpolated third image signal as the output signal when the two-dimensional image is outputted.

According to a study by the present inventors, the following matter is found; namely, when a video consisting of the two-dimensional images is outputted, a frame image associated with the two-dimensional image is outputted generally at 60 fps (frame per second). On the other hand, when a video consisting of the three-dimensional images is outputted, the left-eye image and the right-eye image associated with the three-dimensional image are outputted alternately, for example, at 120 fps.

Here, a synchronization signal differs between the case where the video consisting of the two-dimensional images is outputted at 60 fps and in the case where the video consisting of the three-dimensional images is outputted at 120 fps. Then, depending on the outputting device, the synchronization signal is reset due to the change in the frame frequency or the resolution, in transition for changing between the video consisting of the two-dimensional images and the video consisting of the three-dimensional images. As a result, in the transition, for example, a black screen or the like is outputted for several hundred ms (milliseconds) to several seconds and audio is likely interrupted.

In particular, in the case of a Blu-Ray disc, for example, there is a possibility that a main content video consisting of the three-dimensional images and a special content video consisting the two-dimensional images coexist in one disc. In addition, output of the video consisting of the three-dimensional images and output of the video consisting the two-dimensional images can be also controlled by a control command for reproduction of the Blu-Ray disc, and the output of the video consisting of the three-dimensional images and the output of the video consisting the two-dimensional images are likely changed dynamically. As a result, in the reproduction of the Blu-Ray disc, the synchronization signal is likely reset, relatively frequently.

However, in the present invention, by the interpolating device, the third image signal is interpolated such that the frame frequency and the resolution associated with the third image signal match the frame frequency and the resolution associated with each of the first image signal and the second image signal when the two-dimensional image is outputted. Thus, the frame frequency and the resolution are not changed in the transition for changing between the video consisting of the two-dimensional images and the video consisting of the three-dimensional images. Therefore, since the synchronization signal is not reset in the transition, images and audio are not distorted.

As a result, according to the image output apparatus of the present invention, it is possible to change between the two-dimensional image and the third-dimensional image without distorting images and audio.

In one aspect of the image output apparatus of the present invention, the interpolating device interpolates the third image signal by performing frame frequency conversion on the third image signal.

According to this aspect, it is possible to match the frame frequency associated with the third image signal with the frame frequency of the third-dimensional image associated with each of the first image signal and the second image signal, relatively easily, which is extremely useful in practice.

Alternatively, in another aspect of the image output apparatus of the present invention, the interpolating device interpolates the third image signal by performing an arithmetic process on the third image signal and by generating an image signal associated with a quasi-three-dimensional image.

According to this aspect, by the interpolating device, the arithmetic process is performed on the third image signal, and the image signal associated with the quasi-three-dimensional image is generated. Specifically, for example, by the interpolating device, the arithmetic process is performed on one image corresponding to the third image signal, and an interpolation image which is an image constituting one portion of the quasi-three-dimensional image is generated. As a result, the interpolated third image signal (i.e. an image signal associated with the generated quasi-three-dimensional image) includes the one image (i.e. an original image) and the interpolation image.

Then, if the original image and the interpolation image are outputted alternately, it is possible to match the frame frequency with the frame frequency of the three-dimensional image associated with each of the first image signal and the second image signal, relatively easily. Incidentally, the original image constitutes another portion of the quasi-three-dimensional image.

Since the interpolation image is the image constituting one portion of the quasi-three-dimensional image, the alternate output of the original image and the interpolation image allows the user to feel a three-dimensional appearance close to the three-dimensional image. As a result, for example, when the user watches an image associated with the output signal outputted from the image output apparatus on a three-dimension supported display or the like, it is possible to reduce an uncomfortable feeling produced in changing between the three-dimensional image and the two-dimensional image.

Incidentally, the interpolation image may be generated as the image for producing the binocular disparity effect between the original image and the interpolation image. Specifically, for example, the interpolation image may be generated by shifting the original two-dimensional image by a predetermined offset value.

The expression “shifting . . . by the predetermined offset value” means shifting, by the predetermined offset value, coordinates in the original two-dimensional image of an object shown in the original two-dimensional image. Incidentally, the predetermined offset value may be set for each image output apparatus, as occasion demands.

In another aspect of the image output apparatus of the present invention, it is further provided with: a first decoder unit for functioning as the first decoding device and the third decoding device; and a second decoder unit for functioning as the second decoding device.

According to this aspect, since the first decoder unit has the functions of the first decoding device and the third decoding device, it is possible to reduce the number of parts which constitute the image output apparatus. This allows miniaturization and cost reduction of the image output apparatus, which is extremely useful in practice.

In another aspect of the image output apparatus of the present invention, the outputting device is a HDMI interface.

According to this aspect, the outputting device complies with a High-Definition Multimedia Interface (HDMI) (registered trademark) standard. Thus, it is possible to output a relatively high-definition image, which is extremely useful in practice.

The operation and other advantages of the present invention will become more apparent from Mode for Carrying Out the Invention explained below.

### BRIEF DESCRIPTION OF DRAWINGS

FIG. 1 is a block diagram showing a configuration of an image output apparatus in an embodiment of the present invention.

FIG. 2 are conceptual views showing one example of a synchronization signal.

FIG. 3 are conceptual views showing one example of an interpolation process in a video interpolation circuit in the embodiment of the present invention.

FIG. 4 are conceptual views showing one example of an interpolation process in a video interpolation circuit in a modified example of embodiment of the present invention.

### MODE FOR CARRYING OUT THE INVENTION

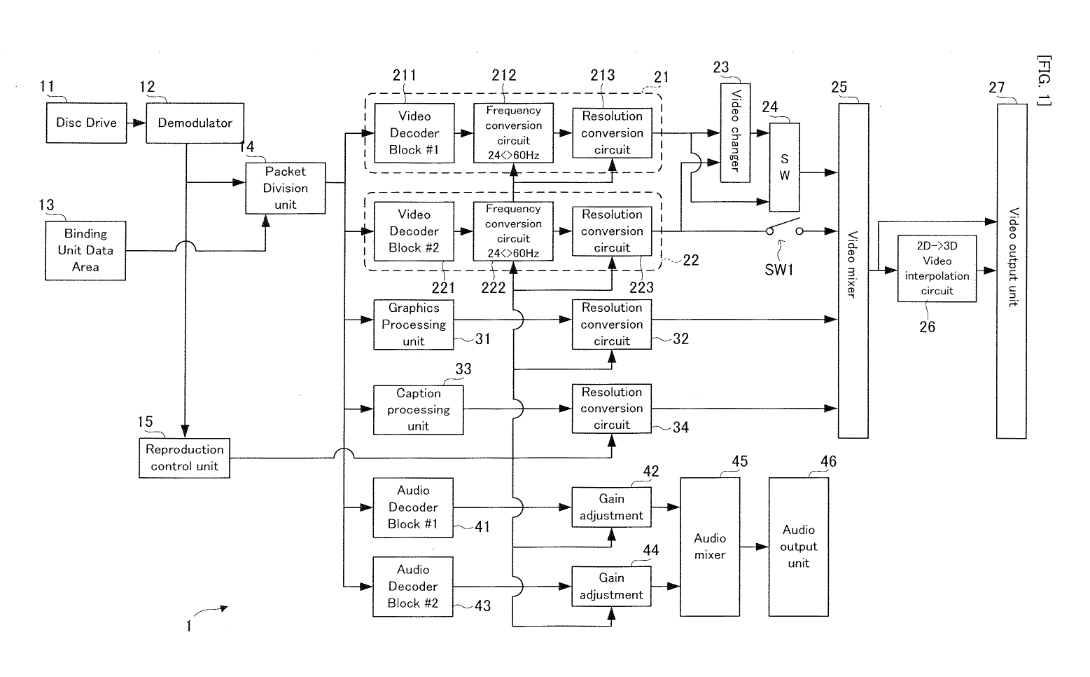

Hereinafter, an image output apparatus in an embodiment of the present invention will be explained with reference to FIG. 1 to FIG. 3.

Firstly, a configuration of the image output apparatus in the embodiment of the present invention will be explained with reference to FIG. 1. FIG. 1 is a block diagram showing the configuration of the image output apparatus in the embodiment of the present invention. Incidentally, an arrow in FIG. 1 indicates a flow of a signal.

In FIG. 1, an image output apparatus 1 is provided with a disc drive 11, a demodulator 12, a binding unit data area (BUDA) 13, a packet division unit 14, a reproduction control unit 15, a first decoder unit 21, a second decoder unit 22, a video changer 23, a switch (SW) 24, a video mixer 25, a video interpolation circuit 26, a video output unit 27, a graphics processing unit 31, resolution conversion circuit 32 and 34, a caption processing unit 33, an audio decoder block #1 41, gain adjustment units 42 and 44, an audio decoder block #2 43, an audio mixer 45, and an audio output unit 46.

The first decoder unit 21 is provided with a video decoder block #1 211, a frequency conversion circuit 212, and a resolution conversion circuit 213.

The second decoder unit 22 is provided with a video decoder block #2 221, a frequency conversion circuit 222, and a resolution conversion circuit 223.

A signal outputted from the disc drive 11 is inputted to the demodulator 12 and is demodulated by the demodulator 12 and then is transmitted to the packet division unit 14 and the reproduction control unit 15. Moreover, a signal outputted from the BUDA 13, which is an area for storing data (e.g. data on a hard disk, a USB memory, and a network) other than a Blu-ray disc, is inputted to the packet division unit 14.

A signal outputted from the packet division unit 14 is inputted to each of the video decoder blocks 211 and 221, the graphics processing unit 31, the caption processing unit 33, and the audio decoder blocks 41 and 43.

On the other hand, a control signal outputted from the reproduction control unit 15 is inputted to each of the resolution conversion circuits 32, 34, 213, and 223, the gain adjustment circuits 42 and 44, and the frequency conversion circuits 212 and 222.

A signal outputted from the graphics processing unit 31 is inputted through the resolution conversion circuit 32 to the video mixer 25. A signal outputted from the caption processing unit 33 is inputted through the resolution conversion circuit 34 to the video mixer 25.

A signal outputted from the audio decoder block 41 is inputted through the gain adjustment unit 42 to the audio mixer 45. A signal outputted from the audio decoder block 43 is inputted through the gain adjustment unit 42 to the audio mixer 45. A signal outputted from the audio mixer 45 is inputted to the audio output unit 46.

If the signal outputted from the packet division unit 14 is a signal associated with a three-dimensional video (hereinafter referred to as a “3D video”) consisting of three-dimensional images, the video decoder block 211 decodes a signal associated with a left-eye video of the 3D video as one example of the “left-eye image data” of the present invention, and outputs the decoded signal associated with the left-eye video as one example of the “first image signal” of the present invention. On the other hand, the video decoder block 221 decodes a signal associated with a right-eye video of the 3D video as one example of the “right-eye image data” of the present invention, and outputs the decoded signal associated with the right-eye video as one example of the “second image signal” of the present invention.

Incidentally, if the signal outputted from the packet division unit 14 is the signal associated with the 3D video, a switch SW1 becomes into an off state (i.e. a state in which the switch SW1 is open). Moreover, the “signal associated with the 3D video” in the embodiment is one example of the “three-dimensional image data” of the present invention.

The decoded signal associated with the left-eye video outputted from the video decoder block 211 is inputted through the frequency conversion circuit 212 and the resolution conversion circuit 213 to the video changer 23. On the other hand, the decoded signal associated with the right-eye video outputted from the video decoder block 221 is inputted through the frequency conversion circuit 222 and the resolution conversion circuit 223 to the video changer 23.

The video changer 23 outputs the decoded signal associated with the left-eye video (i.e. the signal outputted from the video decoder block 211) and the decoded signal associated with the right-eye video (i.e. the signal outputted from the video decoder block 221) alternately at predetermined intervals. Specifically, for example, if the signal outputted from each of the video decoder blocks 211 and 221 has a frame rate of 60 fps, a signal outputted from the video changer 23 has a frame rate of 120 fps because the decoded signal associated with the left-eye video and the decoded signal associated with the right-eye video are outputted alternately.

The signal outputted from the video changer 23 is inputted through the switch 24 to the video mixer 25. On the video mixer 25, a signal outputted from the switch 24, the signal outputted from the graphics processing unit 31, and the signal outputted from the caption processing unit 33 are mixed, and a mixed signal is transmitted to the video output unit 27 such as, for example, a HDMI interface, without through the video interpolation circuit 26.

If the signal outputted from the packet division unit 14 is a signal associated with a two-dimensional video (hereinafter referred to as a “2D video”) consisting of two-dimensional images, the video decoder block 211 decodes a signal associated with a main video of the 2D video, and outputs the decoded signal associated with the main video as one example of the “third image signal” of the present invention. On the other hand, the video decoder block 212 decodes a signal associated with a sub video of the 2D video, and outputs the decoded signal associated with the sub video.

Incidentally, if the signal outputted from the packet division unit 14 is the signal associated with the 2D video, the switch SW1 becomes into an on state (i.e. a state in which the switch SW1 is closed). Moreover, the “signal associated with the 2D video” in the embodiment is one example of the “two-dimensional image data” of the present invention.

The decoded signal associated with the main video outputted from the video decoder block 211 is inputted through the frequency conversion circuit 212 and the resolution conversion circuit 213, but not through the video changer 23, to the switch 24, and the signal outputted from the switch 24 is inputted to the video mixer 25. On the other hand, the decoded signal associated with the sub video outputted from the video decoder block 221 is inputted through the frequency conversion circuit 222 and the resolution conversion circuit 223 to the video mixer 25.

On the video mixer 25, the signal outputted from the switch 24 (i.e. the signal outputted from the video decoder block 211), the signal outputted from the video decoder block 221, the signal outputted from the graphics processing unit 31, and the signal outputted from the caption processing unit 33 are mixed, and a mixed signal is transmitted to the video interpolation circuit 26.

On the video interpolation circuit 26, a quasi-three-dimensional process as one example of the “arithmetic process” of the present invention is performed on the signal mixed by the video mixer 25, and the signal subject to the quasi-three-dimensional process as one example of the “interpolated third image signal” is transmitted to the video output unit 27.

The “video decoder block 211” in the embodiment is one example of the “first decoding device” and the “third decoding device” of the present invention. Each of the “video decoder block 221”, the “video interpolation circuit 26”, and the “video output unit 27” in the embodiment is respective one example of the “second decoding device”, the “interpolating device”, and the “outputting device” of the present invention. Each of the “video changer 23”, the “switch 24”, and the “switch SW1” is one example of the “switching device” of the present invention.

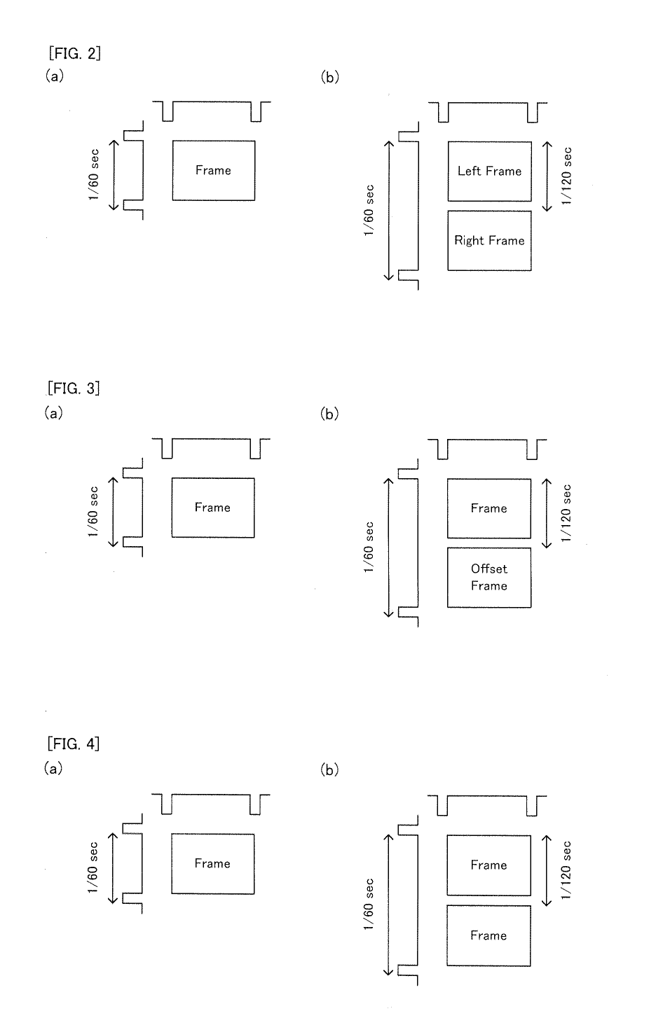

Next, the quasi-three-dimensional process in the embodiment will be explained with reference to FIG. 2 and FIG. 3.

As described above, in the case of the 3D video, since the signal associated with the left-eye video and the signal associated with the right-eye video are inputted to the video changer 23, the video changer 23 outputs the signal associated with the left-eye video and the signal associated with the right-eye video alternately at the predetermined intervals. Thus, for example, if each of the signal associated with the left-eye video and the signal associated with the right-eye video has a frame rate of 60 fps, the signal outputted from the video changer 23 has a frame rate of 120 fps.

On the other hand, in the case of the 2D video, the signal associated with the main video is inputted to the video mixer 25 without through the video changer 23. Thus, the frame rate (e.g. 60 fps) of the signal associated with the main video is not changed.

Then, if no measure is taken, as shown in FIG. 2, a synchronization signal of a video in the case of the output of the 2D video (refer to FIG. 2(a)) and a synchronization signal of a video in the case of the output of the 3D video (refer to FIG. 2(b)) are different from each other. Incidentally, FIG. 2 are conceptual views showing one example of the synchronization signal.

According to a study by the present inventors, it is found that in a HDMI interface, due to its characteristics, the synchronization signal is reset in transition in which resolution or a frame frequency or the like changes (i.e. in changing from the 3D video to the 2D video, etc.). As a result, in the transition, for example, a black screen or the like is outputted for several hundred ms to several seconds and audio is likely interrupted.

However, in the embodiment, the arithmetic process is performed on one frame image corresponding to the signal associated with the 2D video to generate an interpolation image which constitutes one portion of a quasi-three-dimensional image. Here, the interpolation image is generated as an image for producing a binocular disparity effect between the interpolation image and the one frame image. Incidentally, the interpolation image may be generated, for example, by shifting the one frame image by a predetermined offset value.

Then, the video interpolation circuit 26 outputs a signal associated with the one frame image and a signal associated with the interpolation image alternately at predetermined intervals. Thus, for example, if the signal associated with the 2D video inputted to the video interpolation circuit 26 has a frame rate of 60 fps (refer to FIG. 3(a)), the signal outputted from the video interpolation circuit 26 has a frame rate of 120 fps (refer to FIG. 3(b)). Incidentally, FIG. 3 are conceptual views showing one example of the interpolation process in the video interpolation circuit in the embodiment.

As a result, the synchronization signal of the video in the case of the output of the 2D video outputted from the video interpolation circuit 26 matches the synchronization signal of the video in the case of the output of the 3D video (refer to FIG. 2(b)). Therefore, the synchronization signal is not reset in the transition, and thus, images and the audio are not distorted.

When a user watches the 3D video on a three-dimensional video device for displaying the 3D video by using lenses having special optical properties or by using the binocular disparity to the naked eye, if the 3D video is changed to the 2D video, there is a possibility that video depth changes drastically. However, in the embodiment, the interpolation image is generated so as to produce the binocular disparity effect between the original image and the interpolation image. Thus, even if the 3D video is changed to the 2D image, the change in the video depth can be suppressed.

Incidentally, in the embodiment, the signal associated with the main video of the 2D video and the signal associated with the left-eye video of the 3D video are decoded on the same video decoder block; however, there may be separately provided a video decoder block for decoding the signal associated with the 2D video and a video decoder block for decoding the signal associated with the 3D video.

### Modified Example

Next, a modified example of the image output apparatus in the embodiment will be explained with reference to FIG. 4.

In the image output apparatus in the modified example, if the signal outputted from the packet division part 14 is the signal associated with the 2D video, a frame-rate conversion process is performed on the signal mixed by the video mixer 25 on the video interpolation circuit 26, and the signal subject to the frame-rate conversion process as another example of the “interpolated third image signal” is transmitted to the video output unit 27.

Specifically, each frame image corresponding to the signal associated with the 2D video is outputted twice by the video interpolation circuit 26.

Thus, for example, if the signal associated with the 2D video inputted to the video interpolation circuit 26 has a frame rate of 60 fps (refer to FIG. 4(a)), the signal outputted from the video interpolation circuit 26 has a frame rate of 120 fps (refer to FIG. 4(b)). Incidentally, FIG. 4 are conceptual views showing one example of the interpolation process in the video interpolation circuit in the modified example of the embodiment.

As a result, the synchronization signal of the video in the case of the output of the 2D video outputted from the video interpolation circuit 26 matches the synchronization signal of the video in the case of the output of the 3D video (refer to FIG. 2(b)). Therefore, the synchronization signal is not reset in the transition, and thus, images and the audio are not distorted.

The present invention is not limited to the aforementioned embodiment, but various changes may be made, if desired, without departing from the essence or spirit of the invention which can be read from the claims and the entire specification. An image output apparatus, which involves such changes, is also intended to be within the technical scope of the present invention.

### DESCRIPTION OF REFERENCE CODES

1 image output apparatus
21 first decoder unit
22 second decoder unit
23 video changer
24 SW1
25 video mixer
26 video interpolation circuit
27 video output unit
211, 221 video decoder block
212, 222 frequency conversion circuit
212, 223 resolution conversion circuit

1. An image output apparatus capable of changing between and outputting a three-dimensional image corresponding to three-dimensional image data including left-eye image data and right-eye image data and a two-dimensional image corresponding to two-dimensional image, said image output apparatus comprising:
a first decoding device for decoding one image data of the left-eye image data and the right-eye image data and for outputting a first image signal corresponding to the one image data;
a second decoding device for decoding the other image data of the left-eye image data and the right-eye image data and for outputting a second image signal corresponding to the other image data;
a third decoding device for decoding the two-dimensional image data and for outputting a third image signal corresponding to the two-dimensional image data;
a switching device for selecting the first image signal and the second image signal alternately at predetermined intervals when the three-dimensional image is outputted and for selecting the third image signal when the two-dimensional image is outputted;
an interpolating device for interpolating the third image signal such that a frame frequency and resolution associated with the third image signal match a frame frequency and resolution associated with each of the first image signal and the second image signal when the two-dimensional image is outputted; and
an outputting device for outputting the first image signal and the second image signal as an output signal when the three-dimensional image is outputted and for outputting the interpolated third image signal as the output signal when the two-dimensional image is outputted.

2. The image output apparatus according to claim 1, wherein said interpolating device interpolates the third image signal by performing frame frequency conversion on the third image signal.

3. The image output apparatus according to claim 1, wherein said interpolating device interpolates the third image signal by performing an arithmetic process on the third image signal and by generating an image signal associated with a quasi-three-dimensional image.

4. The image output apparatus according to claim 1, further comprising:
a first decoder unit for functioning as said first decoding device and said third decoding device; and
a second decoder unit for functioning as said second decoding device.

5. The image output apparatus according to claim 1, wherein said outputting device is a HDMI interface.
